(19) United States
(12) Patent Application Publication
(10) Pub. No.: US 2025/0280856 A1
(43) Pub. Date: Sep. 11, 2025

(54) APPARATUS FOR FORMING A CONSUMABLE PRODUCT FROM A SOLID BLOCK WITH STRAWSTICK

(71) Applicant: John Chen, Alpharetta, GA (US)

(72) Inventor: John Chen, Alpharetta, GA (US)

(21) Appl. No.: 18/595,663

(22) Filed: Mar. 5, 2024

(51) Int. Cl. A23L 2/56

(52) U.S. Cl. CPC A23L 2/56

(57) ABSTRACT

A solid beverage block with strawstick according to various aspects of the present technology is configured to provide a measured amount of particles that can be dissolved or brewed in a liquid to create a flavored beverage. In one embodiment, the solid beverage block comprises a plurality of ingredients or particles formed into a block and a hollow tube extending at least part way into the solid block. The hollow tube may be used to stir or agitate the solid block within the liquid to integrate the particles into the liquid. The hollow tube may also serve as a straw allowing the user to drink the resulting beverage.

### BACKGROUND OF THE INVENTION

Beverages are often made just prior to drinking by using products such as milk powder, ground coffee, tea, soybean milk powder, cocoa powder, nutritional supplements, etc. To facilitate the products being more easily dissolved in a given liquid, the products are generally made into powders or granules. Utensils such as spoons and other tools may be used to stir the liquid to increase the rate the products are dissolved. In some instances, products may be placed into porous bags (e.g., tea bags) as generally loose powders or dried leaves which can be submerged in the liquid and brewed.

### SUMMARY OF THE INVENTION

A solid beverage block with strawstick according to various aspects of the present technology is configured to provide a measured amount of particles that can be dissolved or brewed in a liquid to create a beverage. In one embodiment, the solid beverage block comprises a plurality of particles pressed into a block and a hollow tube extending at least part way into the solid block. The hollow tube may be used to stir or agitate the solid block within the liquid to integrate the particles into the liquid. The hollow tube may also serve as a straw allowing the user to drink the resulting beverage.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a solid beverage block with strawstick in accordance with an exemplary embodiment of the present technology;

FIG. 2 representatively illustrates the solid beverage block of FIG. 1 placed within a porous bag in accordance with an exemplary embodiment of the present technology;

FIG. 3 representatively illustrates a side view of the solid beverage block with strawstick placed into a container holding a liquid in accordance with an exemplary embodiment of the present technology; and

FIG. 4 representatively illustrates a side view of the strawstick placed into a container holding a liquid after the solid block has been dissolved in accordance with an exemplary embodiment of the present technology.

Elements and steps in the figures are illustrated for simplicity and clarity and have not necessarily been rendered according to any particular sequence. For example, components that may be coupled together in the manner shown or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of particles, granules, powders, flowers, leaves, seeds, and like ingredients, which may be used to create a beverage. In addition, the present technology may be practiced in conjunction with any number of processes for creating a beverage or edible product such as a soup and the system described is merely one exemplary application for the technology. Further, the present technology may employ any number of conventional techniques for dissolving or infusing flavors into a liquid for consumption.

Methods and apparatus for creating a consumable product from a solid block with strawstick according to various aspects of the present technology may operate in conjunction with any suitable liquid used as a base for a consumable product. Various representative implementations of the present technology may be applied to any system for mixing, creating, forming, or otherwise making a drinkable beverage or edible product such as a soup from a fixed amount of ingredients. For example, in one embodiment, the solid block with strawstick may be inserted into a personal sized drinking container or bowl filled with a predetermine amount of liquid such as water or milk. Alternatively, the solid block may be adapted for a larger volume such as stockpot filled with water.

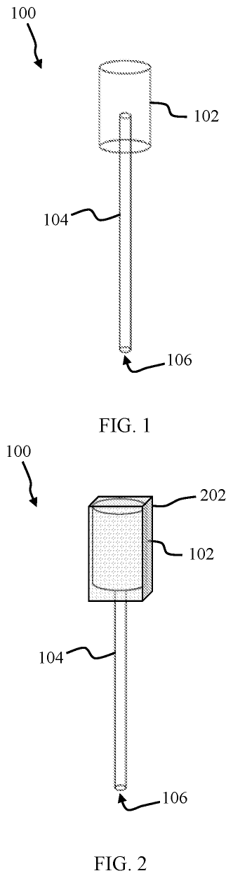

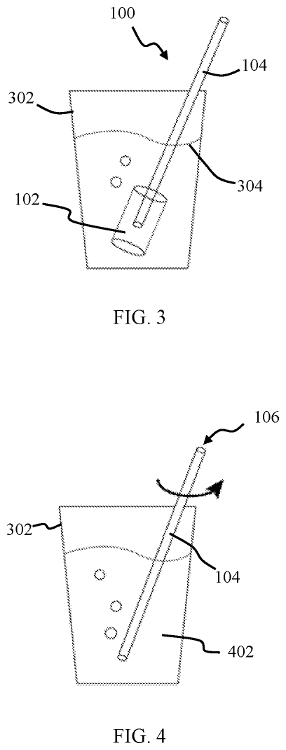

Referring now to FIGS. 1-4, a solid block with strawstick 100 may comprise a block 102 coupled to a strawstick 104. The block 102 is configured to be placed into a container 302 holding a volume of liquid 304, such as water, and agitated or stirred to cause the block 102 to create a flavored beverage 402. The block 102 may comprise any suitable ingredients capable of transferring flavor to the liquid 304. The ingredients may be in any suitable particulate form such as a powder or granule. The ingredients may also include loose dried leaves, flowers, or any portion thereof.

The block 102 may be formed by any suitable method or process. In one embodiment, the ingredients may be pressed together into a shape similar to that of a lollipop or sucker. Alternatively, the ingredients may be poured into a mold and left to reach a predetermined hardness. The ingredients making up the block 102 may be held together by any suitable method. For example, an amount of liquid sweetener may be mixed into the ingredients to act as a binding agent during the pressing process. As another example, the ingredients may be mixed together and heated to form a liquid mixture that can be poured into a mold until hardened sufficiently to form the block 102.

For example, in one embodiment, the block 102 may comprise a plurality of particles pressed together to form a solid block. The pressing process may introduce heat to the particles which may cause a solid sweetening agent to soften and act as a binder to the other ingredients after the pressing process. When placed into a volume of water 304, the plurality of particles forming the block 102 may dissolve and form a flavored beverage 402. In an alternative embodiment, the block 102 may comprise a plurality of particles that do not dissolve in the liquid but may instead rehydrate and infuse the liquid with flavor in a similar manner as tea leaves and ground coffee. In some embodiments, the block 102 may comprise a combination of dissolvable and non-dissolvable ingredients that may produce a beverage such as a tea that is sweetened or has added cream.

In another embodiment, the block 102 may comprise ingredients selected to create a mixed cocktail. The block 102 may be comprised of nonalcoholic ingredients that create a mixed cocktail when dissolved into a volume of alcohol. For example, the block 102 may be formed from things such as bitters, powdered juice, sweeteners, or any other ingredient that could be formed into the block 102.

In yet another embodiment, the block 102 may comprise ingredients selected to provide a nutritional supplement or a pre- or post-workout benefit. For example, the ingredient particles used to form the block 102 may be selected to aid in the recovery process following a workout or other physically exhausting activity.

The block 102 may be formed in any suitable size or shape selected according to any desired criteria. For example, the block 102 may be formed in a shape selected to control a rate at which the ingredients/particles making up the block dissolve into the liquid. In an alternative example, the size of the block 102 may be determined according to the volume of liquid 304 the block 102 is intended to flavor. In one embodiment, the block 102 may be sized to provide sufficient flavor to 8-10 ounces (236-296 ml) of water. One of ordinary skill in the art will understand that any desired amount of liquid may be selected which would have an impact on the amount of ingredients required to provide proper flavoring and the size of the block 102 would change accordingly.

In yet another embodiment, the block 102 may be formed into designs or shapes of various characters or items. For example, the block 102 may be formed into a shape of a children's cartoon character or into the shape of a ball used in a particular sport.

With particular reference to FIG. 2, in embodiments using non-dissolvable ingredients, the block 102 may be placed inside of a mesh bag 202 coupled to the strawstick 104. The mesh bag 202 may be porous to allow the liquid 304 to reach the block 102 in a similar manner as found with tea bags or satchels. This would allow the ingredients to infuse into the liquid 304 without being dispersed into the liquid 304.

The strawstick 104 provides a way to handle the block 102 without a user actually having to touch the block 102 itself. The strawstick 104 may also allow the block 102 to be stirred or otherwise moved within the liquid 304 as the ingredients/particles are flavoring the liquid 304. This may allow a user to increase or decrease the rate at which the block 102 is flavoring the liquid 304 or to control how much flavoring is added to the liquid 304.

The strawstick 104 may comprise a tube having a hollow interior 106 to allow the strawstick 104 to also be used as a straw. Accordingly, the strawstick 104 may be made from any material capable of being exposed to a liquid 304 for an extended period of time without dissolving or otherwise losing its structural integrity. Still, the strawstick 104 may be formed of materials that are biodegradable over a longer period of time than would normally take for a user to consume the flavored beverage 402.

The strawstick 104 may be coupled to the block 104 by any suitable method that allows the user to handle the block 102 before and during the time the block 102 is placed into the liquid 304. In one embodiment, the strawstick 104 may be at least partially inserted into the block 102 during the time when the block is being formed. Alternatively, in another embodiment, the strawstick 104 may be positioned in the mold prior to the ingredients being poured into the mold.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to a preferred embodiment. However, changes and modifications may be made to the preferred embodiment without departing from the scope of the present invention. These and other changes or modifications are intended to be included within the scope of the present technology, as expressed in the following claims.

1. A solid block for creating a flavored beverage from a quantity of liquid in a container, comprising:
a block comprising one or more particles configured to flavor the liquid; and
a strawstick having a first end extending at least part way into the block.

2. A solid block for creating a flavored beverage according to claim 1, wherein the particles dissolve into the liquid when the block is inserted into the liquid and create the flavored beverage.

3. A solid block for creating a flavored beverage according to claim 1, wherein the particles infuse into the liquid when the block is inserted into the liquid and create the flavored beverage.

4. A solid block for creating a flavored beverage according to claim 3, wherein the block is contained within a mesh bag coupled to the strawstick.

5. A solid block for creating a flavored beverage according to claim 4, wherein the mesh bag prevents the particles from being distributed into the liquid.

6. A solid block for creating a flavored beverage according to claim 1, wherein the strawstick comprises a hollow interior allowing the strawstick to be used as a straw.

7. A solid block for creating a flavored beverage according to claim 1, wherein a second free end of the strawstick extends out from the liquid when the block is inserted into the liquid.

8. A solid block for creating a flavored beverage according to claim 1, wherein the particles are pressed together to form the block.

9. A solid block for creating a flavored beverage according to claim 1, wherein the particles are poured into a mold to form the block.

10. A solid block for creating a flavored beverage according to claim 1, wherein the particles comprise at least one of a powder, granules, leaves, berries, and flower petals.
